(19) United States
(12) Patent Application Publication
(10) Pub. No.: US 2021/0225769 A1
(43) Pub. Date: Jul. 22, 2021

(54) INTEGRATED CIRCUIT STRUCTURE

(71) Applicant: ALi Corporation, Hsinchu (TW)

(72) Inventors: Hsin-Ying Tsai, Hsinchu (TW); Tzu-Wei Lan, Hsinchu (TW); Meng-Che Li, Hsinchu (TW); Wei-Hsien Fang, Hsinchu (TW)

(73) Assignee: ALi Corporation, Hsinchu (TW)

(21) Appl. No.: 17/152,802

(22) Filed: Jan. 20, 2021

(30) Foreign Application Priority Data
Jan. 21, 2020 (CN) 202010071849.3

(51) Int. Cl. H01L 23/528; H01L 23/50; G06F 30/39

(52) U.S. Cl. CPC H01L 23/5286; G06F 30/39; H01L 23/50

(57) ABSTRACT

The invention provides an integrated circuit (IC) structure including a function circuit and a power ground (P/G) mesh electrically connected with the function circuit. The P/G mesh includes a first metal layer and a second metal layer. The first metal layer and the second metal layer are respectively disposed with a plurality of ground wires and a plurality of power wires. The power wires of the first metal layer are electrically connected with the power wires of the second metal layer through a plurality of first vias, and the ground wires of the first metal layer are electrically connected with the ground wires of the second metal layer through a plurality of second vias. A wire impedance of the first metal layer is different from a wire impedance of the second metal layer. The IC structure can achieve reduction of an IR-drop.

### CROSS-REFERENCE TO RELATED APPLICATION

This application claims the priority benefit of China patent application serial no. 202010071849.3, filed on Jan. 21, 2020. The entirety of the above-mentioned patent application is hereby incorporated by reference herein and made a part of this specification.

### BACKGROUND

### Field of the Invention

The invention relates to an integrated circuit (IC) design field and more particularly, to an IC structure related to a design of a power ground (P/G) mesh.

### Description of Related Art

Along with the development of electronic components toward miniaturization and low power consumption, difficulty in designing power supply meshes of integrated circuits (ICs) are also gradually increased. A power supply mesh of an integrated circuit (IC) includes a power mesh and a ground mesh (collectively referred to as a power ground (P/G) mesh). A layout manner of the P/G mesh may influence power supply performance of the electronic components, and thus, the design of the P/G mesh becomes very important. In addition, an impedance of the P/G mesh may cause a significant drop in component voltages. Especially, the farer the components are distant from a power source, the more obvious the components are influenced by the voltage drop, which is commonly referred to as an IR-drop phenomenon. An excessively large or uneven IR-drop may influence circuit performance, and therefore, how to adaptively design the P/G mesh to reduce the IR-drop becomes very important.

### SUMMARY

The invention is directed to an integrated circuit (IC) structure having a power ground (P/G) mesh capable of achieving an effect of reducing an IR-drop.

An IC structure according to an embodiment of the invention includes a function circuit and a power ground (P/G) mesh. The power ground (P/G) mesh is electrically connected with the function circuit and includes a first metal layer and a second metal layer. The first metal layer and the second metal layer are respectively disposed with a plurality of ground wires and a plurality of power wires, the plurality of power wires of the first metal layer are electrically connected with the plurality of power wires of the second metal layer through a plurality of first vias, and the plurality of ground wires of the first metal layer are electrically connected with the plurality of ground wires of the second metal layer through a plurality of second vias. A wire impedance of the first metal layer is different from a wire impedance of the second metal layer.

According to the IC structure of the invention, the configuration of the power ground mesh could keep a more even and balanced resistance distribution in signal transmission paths and provide reliable system voltages to increase the IC performance.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating an integrated circuit (IC) structure according to an embodiment of the invention.

FIG. 2 is a schematic diagram illustrating circuit patterns of a power ground (P/G) mesh according to an embodiment of the invention.

FIG. 3 is a schematic cross-sectional diagram illustrating wires of a P/G mesh according to an embodiment of the invention.

FIG. 4A is a schematic wiring diagram of the first metal layer of the P/G mesh according to an embodiment of the invention.

FIG. 4B is a schematic wiring diagram of the second metal layer of the P/G mesh according to an embodiment of the invention.

FIG. 5 is a schematic diagram illustrating circuit patterns of a P/G mesh according to an embodiment of the invention.

FIG. 6A is a schematic wiring diagram of the first metal layer of the P/G mesh according to an embodiment of the invention.

FIG. 6B is a schematic wiring diagram of the second metal layer of the P/G mesh according to an embodiment of the invention.

FIG. 7 is a schematic diagram illustrating circuit patterns of a P/G mesh according to an embodiment of the invention.

FIG. 8A is a schematic wiring diagram of the first metal layer of the P/G mesh according to an embodiment of the invention.

FIG. 8B is a schematic wiring diagram of the second metal layer of the P/G mesh according to an embodiment of the invention.

FIG. 9A and FIG. 9B are schematic diagrams respectively illustrating voltage drop tests of various P/G meshes according to the embodiments of the invention.

FIG. 10A through FIG. 10D are schematic diagrams respectively illustrating voltage drop tests of various P/G meshes in different process conditions according to the embodiments of the invention.

### DESCRIPTION OF EMBODIMENTS

Reference will now be made in detail to the exemplary embodiments of the disclosure, examples of which are illustrated in the accompanying drawings. Wherever possible, the same reference numbers are used in the drawings and the description to refer to the same or like parts.

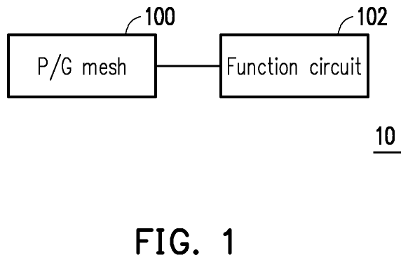

FIG. 1 is a block diagram illustrating an integrated circuit (IC) structure according to an embodiment of the invention. Referring to FIG. 1, an IC 10 includes a power ground (P/G) mesh 100 and a function circuit 102. The P/G mesh 100 is electrically connected with the function circuit 102 and is configured to distribute a system voltage and a ground voltage to the function circuit 102. In the present embodiment, the IC structure 10 includes a substrate (which is not shown), for example, a silicon substrate. A plurality of transistors and a multi-layer wire structure may be disposed on a side of the substrate. The multi-layer wire structure includes, for example, multiple stacked metal layers, such as conventional first metal layer (Metal 1, referred to as M1) and second metal layer (Metal 2, referred to as M2). These metal layers may have respective circuit patterns connected with each other through vias. The vias are implemented by means of, for example, through silicon vias (TSVs), which is not limited in the invention.

The function circuit 102 is composed of the transistors and the multiple metal layers disposed on the substrate. In the present embodiment, the function circuit 102 is a computing circuit occupying a greater area of the substrate and is, for example, a central processing unit (CPU) or a graphics processing unit (GPU), which is not limited in the invention. The circuit patterns of the metal layers are connected with the transistors to form a circuit structure of the function circuit 102. The P/G mesh 100 includes a first metal layer and a second metal layer. The first metal layer and the second metal layer may be stacked with each other and may be, for example, two layers in the multi-layer wire structure, or alternatively, one metal layer in the multi-layer wire structure and a redistribution layer (RDL), which are not limited in the invention.

The first metal layer and the second metal layer are respectively disposed with a plurality of ground wires and a plurality of power wires. The ground wires of the first metal layer are electrically connected with the ground wires of the second metal layer through a plurality of first vias, and the power wires of the first metal layer are electrically connected with the power wires of the second metal layer through a plurality of second vias. It should be specially mentioned that a wire impedance of the first metal layer is different from a wire impedance of the second metal layer in the present embodiment. For example, the RDL and other metal layers may be made of different metal materials and thus have different impedances, or alternatively, the two layers in the multi-layer wire structure are metal layers made of the same material, but configured to have difference parameters based on process requirements, so as to have different impedances.

Several embodiments are provided below to further describe the P/G mesh 100.

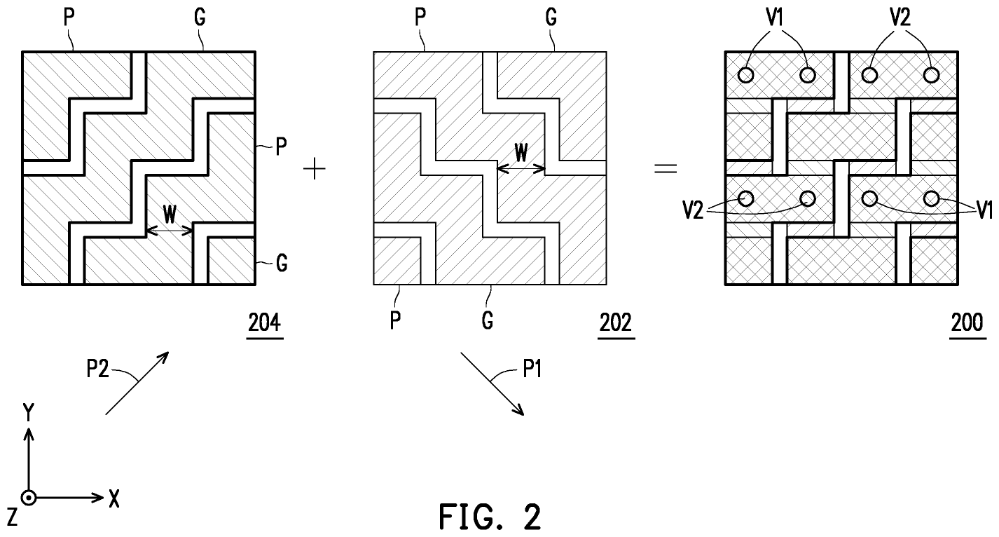

FIG. 2 is a schematic diagram illustrating circuit patterns of a P/G mesh according to an embodiment of the invention. Referring to FIG. 2, the middle figure is a partial top view illustrating a circuit pattern of a first metal layer 202, and the left figure is a partial top view illustrating a circuit pattern of a second metal layer 204. A plurality of ground wires G and a plurality of power wires P of the first metal layer 202 are disposed in a staggered manner, and a plurality of ground wires G and a plurality of power wires P of the second metal layer 204 are also disposed in a staggered manner. Specifically, in FIG. 2, a ground wire G is placed between two power wires P, and a power wire P is placed between two ground wires G. At least a portion of the wires of the ground wires G and the power wires P of the first metal layer 202 form a first pattern, wherein the first pattern is a two-dimensional (2D) pattern. In this embodiment, the first pattern is a stair-shaped pattern extending along a first direction P1, and each stair step in the pattern has a right-angled corner. The first direction P1 could be a direction from lower right to upper left with a slope of negative 1, for example. The ground wires G and the power wires P of the first metal layer 202 may show at least two right-angled corners in the X and Y directions. A wire layout of the first metal layer 202 may be composed of the first pattern and shifting, flipping or rotating of the first pattern.

At least a portion of the wires of the ground wires G and the power wires P of the second metal layer 204 form a second pattern. The second pattern is also a 2D pattern corresponding to the first pattern. In this embodiment, the second pattern is a stair-shaped pattern extending along a second direction P2 that is opposite to the first direction P1. The second direction P2 could be a direction from lower left to upper right with a slope of positive 1, for example. In other words, the first pattern and the second pattern have a shifting, flipping or rotating relation. The ground wires G and the power wires P of the second metal layer 204 may show at least two right-angled corners in the X and Y directions. A wire layout of the ground wires and the power wires of the second metal layer may be composed of the second pattern and shifting, flipping or rotating of the second pattern. In brief, the ground wires G and the power wires P of the first metal layer 202 and the second metal layer 204 respectively constitute of two-dimensional patterns on an extension plane (which is an X-Y plane in this embodiment).

In FIG. 2, the right figure is a partial top view illustrating a P/G mesh 200 after the first metal layer 202 and the second metal layer 204 are stacked. The power wires P of the first metal layer 202 are electrically connected with the power wires P of the second metal layer 204 through first vias V1, and the ground wires G of the first metal layer 202 are electrically connected with the ground wires G of the second metal layer 204 through second vias V2, thereby forming the P/G mesh 200.

In the present embodiment, a wire impedance of the first metal layer 202 may be different from a wire impedance of the second metal layer 204, but the invention is not limited thereto.

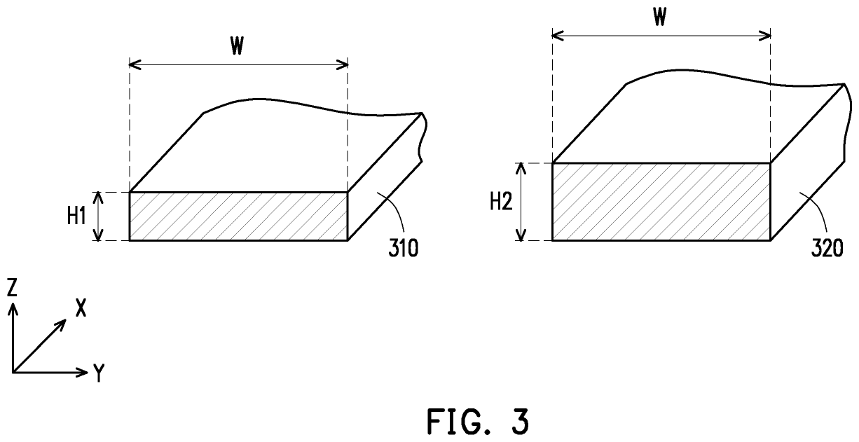

FIG. 3 is a schematic cross-sectional diagram illustrating wires of a P/G mesh according to an embodiment of the invention. Referring to FIG. 3, wire widths of the ground wires G and the power wires P of the first metal layer 202 and the second metal layer 204 are the same, and both are a width W. In the cross-sectional diagram of the wires illustrated in FIG. 3, a wire 310 serves as an example of the wires of the first metal layer 202, and a wire 320 serves as an example of the wires of the second metal layer 204. In the present embodiment, a wire height H1 of the first metal layer 202 is different from a wire height H2 of the second metal layer 204. In other words, the ground wires G and the power wires P of the first metal layer 202 have the same wire height, i.e., the height H1, and the ground wires G and the power wires P of second metal layer 204 have the same wire height, i.e., the height H2, but the height H1 is different from the height H2. For example, the wire height H1 of the first metal layer 202 is 280 nm, and the wire height H2 of the second metal layer 204 is 340 nm.

In another embodiment, the height of the ground wires G and the power wires P of the first metal layer 202 and the height of the ground wires G and the power wires P the second metal layer 204 may be the same, but the wire width of the first metal layer 202 is different from the wire width of the second metal layer 204.

The difference in the wire width or the height may result in difference in impedances of the first metal layer 202 and the second metal layer 204. The invention is not intent to limit the wire widths or the heights of the ground wires G and the power wires P of the first metal layer 202 and the second metal layer 204. In another embodiment, the wire widths and the heights of the first metal layer 202 and the second metal layer 204 are the same, however, the first metal layer 202 and the second metal layer 204 are conductors made of different materials and also have different wire impedances.

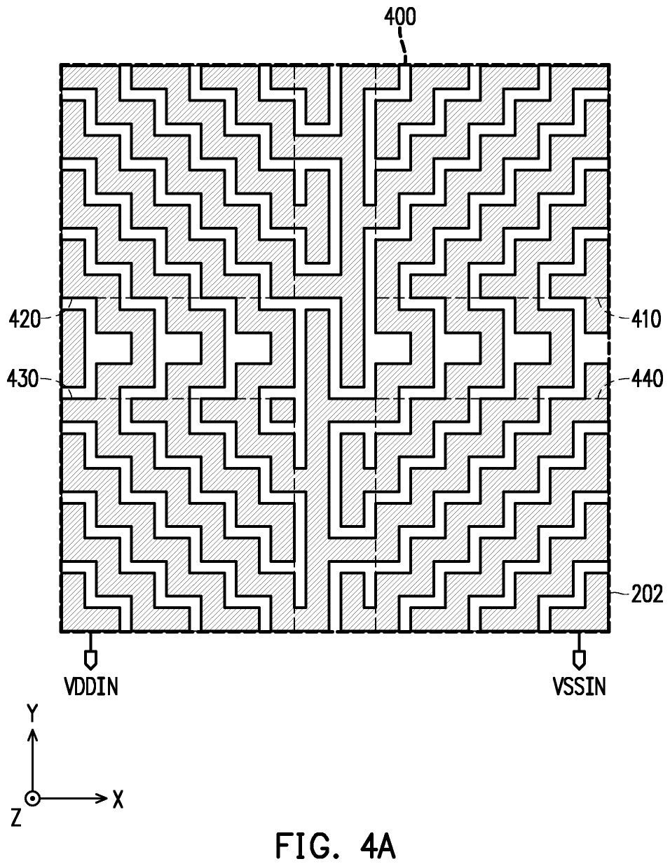

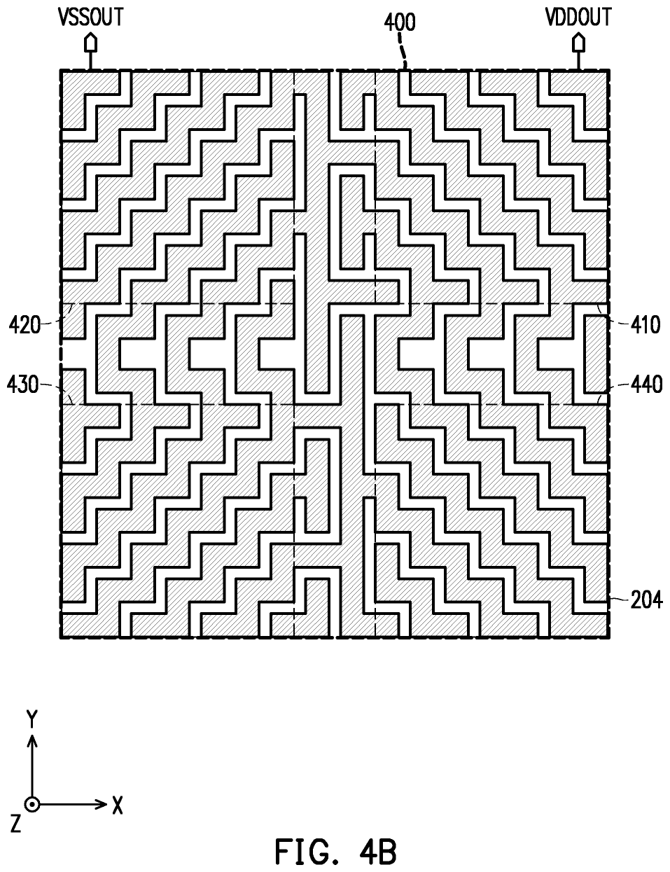

FIG. 4A is a schematic wiring diagram of the first metal layer of the P/G mesh according to an embodiment of the invention. FIG. 4B is a schematic wiring diagram of the second metal layer of the P/G mesh according to an embodiment of the invention. Referring to FIG. 4A and FIG. 4B incorporated with FIG. 2, the wire layout of the first metal layer 202 includes a rectangular unit region 400, wherein the rectangular unit region 400 is divided by a vertical axis and a horizontal axis into a first quadrant region 410, a second quadrant region 420, a third quadrant region 430 and a fourth quadrant region 440. In the first metal layer 202, the second quadrant region 420 is formed by the first pattern as illustrated in FIG. 2. The first quadrant region 410 and the second quadrant region 420 are symmetrical to each other along one of the axes (vertical axis in this embodiment), the third quadrant region 430 is the same as the second quadrant region 420 by shifting the first pattern along the other one of the axes (horizontal axis in this embodiment), and the fourth quadrant region 440 and the third quadrant region 430 are symmetrical to each other along one of the axes (vertical axis in this embodiment). Therefore the fourth quadrant region 440 and the second quadrat region 420 are also symmetrical to each other along one of the axes (either vertical or horizontal axis). The wire layout of the second metal layer 204 may also correspondingly include the rectangular unit region 400. In the second metal layer 204, the second quadrant region 420 is formed by the second pattern. The first quadrant region 410 and the second quadrant region 420 are symmetrical to each other along the vertical axis, the third quadrant region 430 and the second quadrant region 420 are the same, and the fourth quadrant region 440 and the third quadrant region 430 are also symmetrical to each other along the vertical axis.

In the present embodiment, the four quadrants 410 to 440 in the rectangular unit region 400 of the first metal layer 202 or the second metal layer 204 are not necessarily adjacent to one another and may reserve a wiring connection region from one another, and the wiring connection region may also be designed in a symmetrical connection manner, which is not limited in the invention.

In the present embodiment, when any one of the quadrant regions (i.e., any one of 410 to 440) of the first metal layer 202 is formed by one of the first pattern and the second pattern, the quadrant region corresponding to the second metal layer 204 is formed by the other one of the first pattern and the second pattern. In addition, when any one of the quadrant regions (e.g., the second quadrant region 420) of the first metal layer 202 or the second metal layer 204 is formed by one of the first pattern and the second pattern, the diagonal quadrant region (e.g., the fourth quadrant region 440) is formed by the other one of the first pattern and the second pattern. In this way, the P/G mesh 200 formed by the rectangular unit regions 400 would have a more even and balanced resistance distribution in signal transmission paths in comparison with conventional technique. Total numbers of the first vias V1 are same as total numbers of the second vias V2 in the first quadrant region 410, the second quadrant region 420, the third quadrant region 430 and the fourth quadrant region 440.

In the present embodiment, as two diagonal ends of the rectangular unit regions 400 of the first metal layer 202 and the second metal layer 204 being selected to serve as a voltage input terminal (e.g., a system voltage input terminal VDDIN or a ground voltage input terminal VSSIN) and a voltage output terminal (e.g., a system voltage output terminal VDDOUT or a ground voltage output terminal VSSOUT), between the voltage input terminal and the voltage output terminal, at least one of the ground wires G and the corresponding power wires P (e.g., adjacent ground wire G and power wire P) that are distributed in the first metal layer 202 and the second metal layer 204 through the first via V1 and the second via V2 would include a stair-shaped wire having the first direction P1 and a stair-shaped wire having the opposite second direction P2.

In brief, the rectangular unit region 400 of the first metal layer 202 may be generated by the first pattern and shifting, flipping or rotating of the first pattern. In the same way, corresponding to the rectangular unit region 400 of the first metal layer 202, the rectangular unit region 400 of the second metal layer 204 may be generated by the second pattern and shifting, flipping or rotating of the second pattern, wherein the first pattern and the second pattern have a shifting, flipping or rotating relation. A designer may consider the rectangular unit region 400 as a unit region for routing a global wire layout of the P/G mesh.

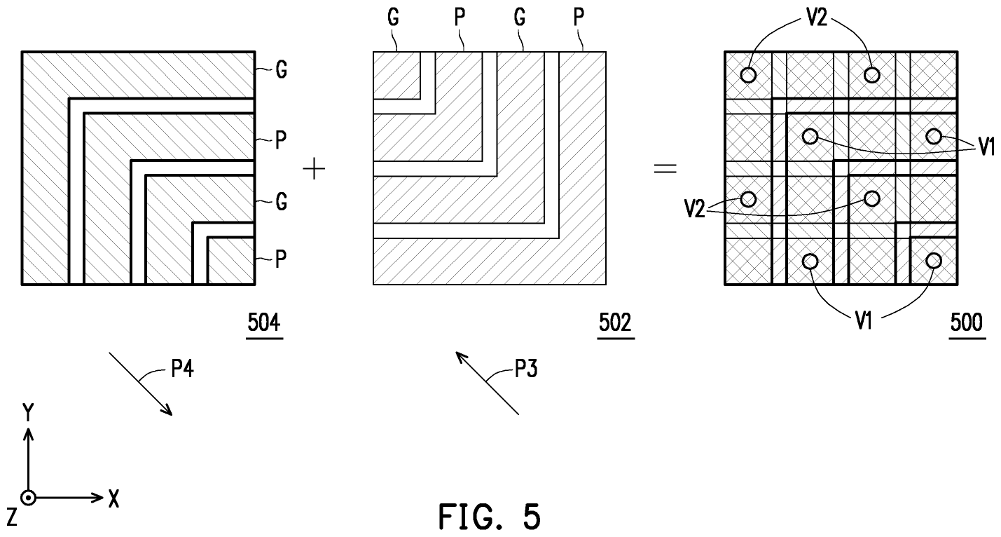

FIG. 5 is a schematic diagram illustrating circuit patterns of a P/G mesh according to an embodiment of the invention. Referring to FIG. 5, the middle figure is a partial top view illustrating a circuit pattern of a first metal layer 502, and the left figure is a partial top view illustrating a circuit pattern of a second metal layer 504. A plurality of ground wires G and a plurality of power wires P of the first metal layer 502 are disposed in a staggered manner, and a plurality of ground wires G and a plurality of power wires P of the second metal layer 504 are also disposed in a staggered manner. Specifically, in FIG. 5, a ground wire G is placed between two power wires P, and a power wire P is placed between two ground wires G. At least a portion of the wires of the ground wires G and the power wires P of the first metal layer 502 form a first pattern, wherein the first pattern is a 2D pattern. In this embodiment, the first pattern comprises L-shaped patterns having an opening direction, and each opening has a right angle. The opening direction of the first pattern is as shown by an arrow P3, which is a direction toward upper left and has an included angle of, for example, 45 degrees with the Y axis. The ground wires G and the power wires P of the first metal layer 502 form at least one right-angled corner on an extension plane (which is the X-Y plane in this embodiment). In other words, the first pattern comprises L-shaped patterns having a right-angled corner. A wire layout of the first metal layer 502 may be composed of the first pattern and shifting, flipping or rotating of the first pattern.

At least a portion of the wires of the ground wires G and the power wires P of the second metal layer 504 form a second pattern. The second pattern is a 2D pattern corresponding to the first pattern. In this embodiment, the second pattern comprises L-shaped patterns having an opening direction opposite to the opening direction of the first pattern. The opening direction of the second pattern is as shown by an arrow P4, which is a direction toward lower right and is, for example, different from the arrow P3 by 180 degrees. In other words, the first pattern and the second pattern have a shifting, flipping or rotating relation. The ground wires G and the power wires P of the second metal layer 504 form at least one right-angled corner on the X-Y plane. A wire layout of the ground wires and the power wires of the second metal layer 504 may be composed of the second pattern and shifting, flipping or rotating of the second pattern. In brief, the ground wires G and the power wires P of the first metal layer 502 and the second metal layer 504 are respectively constitute of two-dimensional patterns on the X-Y plane.

In FIG. 5, the right figure is a partial top view illustrating a P/G mesh 500 after the first metal layer 502 and the second metal layer 504 are stacked. The power wires P of the first metal layer 502 are electrically connected with the power wires P of the second metal layer 504 through first vias V1, and the ground wires G of the first metal layer 502 are electrically connected with the ground wires G of the second metal layer 504 through second vias V2, thereby forming the P/G mesh 500.

It should be mentioned again that a wire impedance of the first metal layer 502 is different from a wire impedance of the second metal layer 504. A wire height of the first metal layer 502 may be different from a wire height of the second metal layer 504, or alternatively, a wire width of the first metal layer 502 may be different from a wire width of the second metal layer 504. Similar descriptions may be referred in the embodiment illustrated in FIG. 3 and would not be repeated herein.

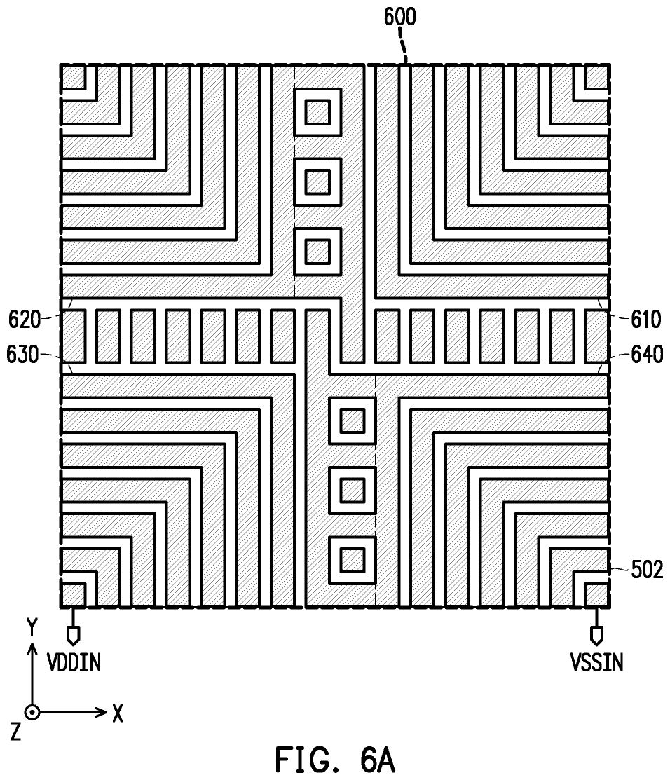

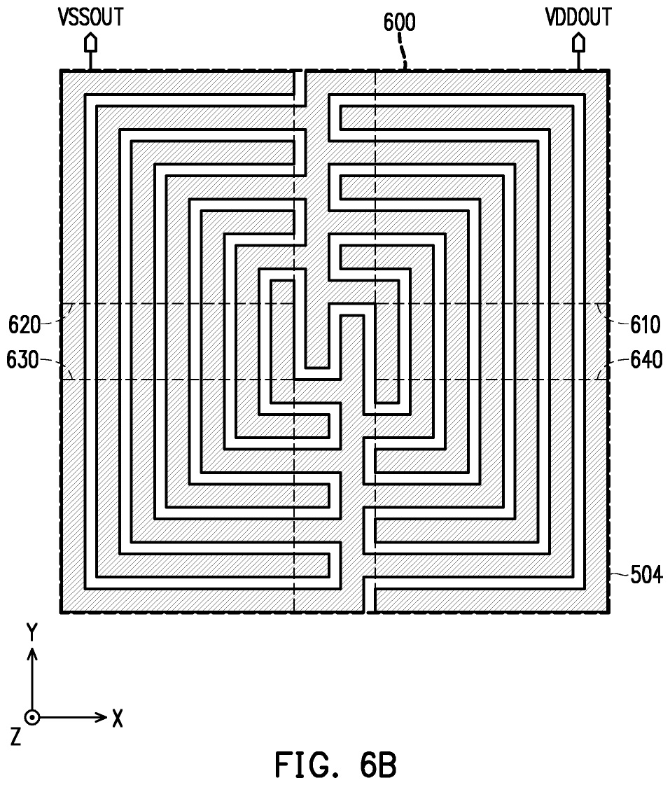

FIG. 6A is a schematic wiring diagram of the first metal layer of the P/G mesh according to an embodiment of the invention. FIG. 6B is a schematic wiring diagram of the second metal layer of the P/G mesh according to an embodiment of the invention. Referring to FIG. 6A and FIG. 6B incorporated with FIG. 5, the wire layout of the first metal layer 502 includes a rectangular unit region 600, wherein the rectangular unit region 600 is divided by a vertical axis and a horizontal axis into a first quadrant region 610, a second quadrant region 620, a third quadrant region 630 and a fourth quadrant region 640. In the first metal layer 502, the second quadrant region 620 is formed by the first pattern illustrated in FIG. 5. The first quadrant region 610 and the second quadrant region 620 are symmetrical to each other along one of the axes, the third quadrant region 630 and the second quadrant region 620 are symmetrical to each other along the other one of the axes, and the fourth quadrant region 640 and the third quadrant region 630 are symmetrical to each other along the same axis as the first and the second regions. In FIG. 6B, the wire layout of the second metal layer 504 may also correspondingly include the rectangular unit region 600. In the second metal layer 504, the second quadrant region 620 is formed by the second pattern, the first quadrant region 610 and the second quadrant region 620 are symmetrical to each other along one of the axes (vertical axis in this embodiment), the third quadrant region 630 and the second quadrant region 620 are symmetrical to each other along the other one of the axes, and the fourth quadrant region 640 and the third quadrant region 630 are symmetrical to each other along one of the axes (vertical axis in this embodiment). In addition, total numbers of the first vias V1 are same as total numbers of the second vias V2 in the first quadrant region 610, the second quadrant region 620, the third quadrant region 630 and the fourth quadrant region 640.

In the present embodiment, the four quadrant regions 610 to 640 in the rectangular unit region 600 of the first metal layer 502 or the second metal layer 504 are not necessarily adjacent to one another and may reserve a wiring connection region from one another, and the wiring connection region may also be designed in a symmetrical connection manner, which is not limited in the invention.

In the present embodiment, when any one of the quadrant regions (i.e., any one of 610 to 640) of the first metal layer 502 is formed by one of the first pattern and the second pattern, the quadrant region corresponding to the second metal layer 504 is formed by the other one of the first pattern and the second pattern. In other words, the opening directions of the L-shaped patterns in the quadrant regions of the first metal layer 502 and those in the corresponding quadrant regions of the second metal layer 504 are opposite to one another. In addition, when any one of the quadrant regions (e.g., the second quadrant region 620) of the first metal layer 202 or the second metal layer 204 is formed by one of the first pattern and the second pattern, the diagonal quadrant region (e.g., the fourth quadrant region 640) is formed by the other one of the first pattern and the second pattern. In this way, the P/G mesh 500 formed by the rectangular unit regions 600 would have a more even and balanced resistance distribution in signal transmission paths in comparison with the conventional technique.

In the present embodiment, as two diagonal ends of the rectangular unit regions 600 being selected to serve as a voltage input terminal (e.g., a system voltage input terminal VDDIN or a ground voltage input terminal VSSIN) and a voltage output terminal (e.g., a system voltage output terminal VDDOUT or a ground voltage output terminal VSSOUT), between the voltage input terminal and the voltage output terminal, at least one of the ground wires and its corresponding power wires would include an L-shaped wire having an opening direction and an L-shaped wire having an opposite opening direction. Namely, voltage signal transmission paths pass through the two L-shaped wires having opposite opening directions.

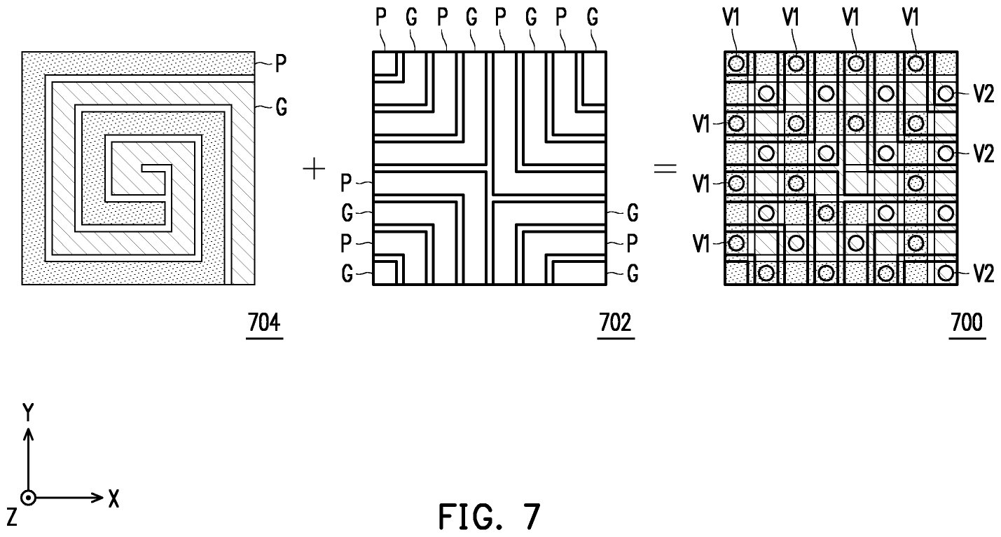

FIG. 7 is a schematic diagram illustrating circuit patterns of a P/G mesh according to an embodiment of the invention. Referring to FIG. 7, the middle figure illustrates a partial top view illustrating a circuit pattern of a first metal layer 702, and the left figure is a partial top view illustrating a circuit pattern of a second metal layer 704. A plurality of ground wires G and a plurality of power wires P of the first metal layer 702 are disposed in a staggered manner, and a plurality of ground wires G and a plurality of power wires P of the second metal layer 704 are also disposed in a staggered manner. Specifically, in FIG. 7, a ground wire G is placed between two power wires P, and a power wire P is placed between two ground wires G. At least a portion of the wires of the ground wires G and the power wires P of the first metal layer 702 form a first pattern, wherein the first pattern is a 2D pattern. In this embodiment, the first pattern is formed by L-shaped patterns having an opening direction (where an opening of the L shape is, for example, 90 degrees). The ground wires G and the power wires P of the first metal layer 702 would be configured to have at least one right-angled corner in the X-Y plane. A wire layout of the first metal layer 702 may be composed of the first pattern and shifting, flipping or rotating of the first pattern.

At least a portion of the wires of the ground wires G and the power wires P of the second metal layer 704 form a second pattern. The second pattern is also a 2D pattern. In this embodiment, the second pattern is a spiral square pattern. The ground wires G and the power wires P of the second metal layer 704 would be configured to have at least four right-angled corners in the X-Y plane. A wire layout of the ground wires and the power wires of the second metal layer 704 may be composed of the second pattern and shifting, flipping or rotating of the second pattern. In brief, the ground wires G and the power wires P of the first metal layer 702 and the second metal layer 704 are respectively constitute of two-dimensional patterns on the extension plane (which is the X-Y plane in this embodiment).

In FIG. 7, the right figure is a partial top view of a P/G mesh after the first metal layer 702 and the second metal layer 704 are stacked. The power wires P of the first metal layer 702 are electrically connected with the power wires P of the second metal layer 704 through first vias V1, and the ground wires G of the first metal layer 702 are electrically connected with the ground wires G of the second metal layer 704 through second vias V2, thereby forming a P/G mesh 700.

It should be mentioned again that a wire impedance of the first metal layer 702 is different from a wire impedance of the second metal layer 704. A wire height of the first metal layer 702 may be different from a wire height of the second metal layer 704, or a wire width of the first metal layer 702 may be different from a wire width of the second metal layer 704. Similar descriptions may be referred in the embodiment illustrated in FIG. 3 and would not be repeated herein.

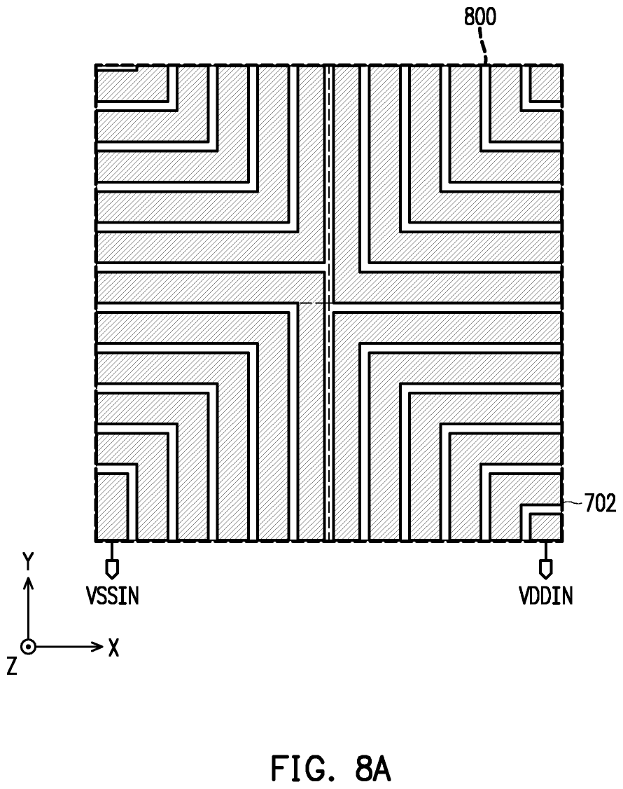

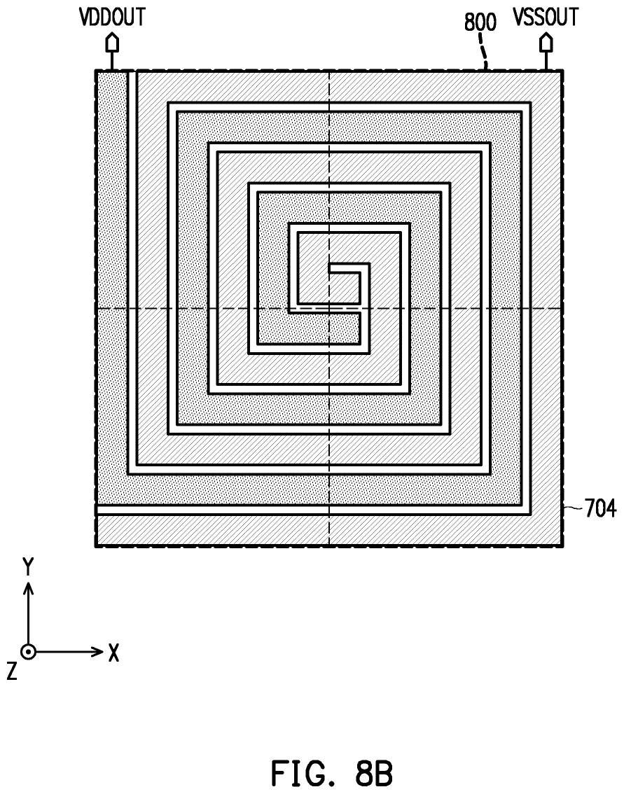

FIG. 8A is a schematic wiring diagram of the first metal layer of the P/G mesh according to an embodiment of the invention. FIG. 8B is a schematic wiring diagram of the second metal layer of the P/G mesh according to an embodiment of the invention. Referring to FIG. 8A and FIG. 8B incorporated with FIG. 7, the wire layout of the first metal layer 702 includes a rectangular unit region 800, and the rectangular unit region 800 of the first metal layer 702 is formed by the first pattern illustrated in FIG. 7. To be more specific, the rectangular unit region 800 of the first metal layer 702 includes a plurality of L-shaped pattern wires having different opening directions (FIG. 8A illustrates L-shaped pattern wires having four different opening directions), and these L-shaped patterns are radially-arranged relative to the center of the rectangular unit region 800. In the present embodiment, the left half and the right half of the rectangular unit region 800 of the first metal layer 702 are rotationally symmetrical to each other. In addition, the opening directions of the diagonal L-shaped patterns in the first metal layer 702 or the second metal layer 704 are opposite to one another.

In FIG. 8B, the wire layout of the second metal layer 704 may also correspondingly include the rectangular unit region 800. The rectangular unit region 800 of the second metal layer 704 is formed by the second pattern illustrated in FIG. 7 and is a spiral square pattern formed by at least one of the ground wires G and at least one of the power wires disposed adjacent to each other in the rectangular unit region 800. The P/G mesh 700 formed by the rectangular unit regions 800 has a more even and balanced resistance distribution in signal transmission paths in comparison with conventional technique.

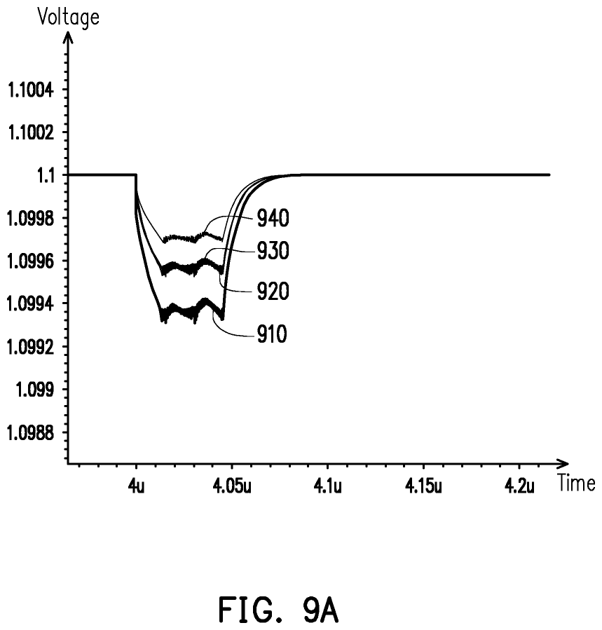

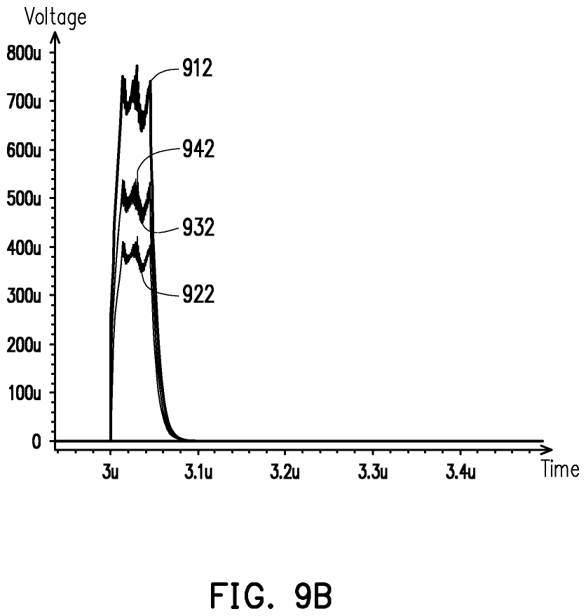

FIG. 9A and FIG. 9B are schematic diagrams respectively illustrating voltage drop tests of various P/G meshes according to the embodiments of the invention. FIG. 9A illustrates transmission results that a system voltage passes through P/G meshes having the same size but different wire layouts, wherein the system voltage is input from a system voltage input terminal (e.g., the system voltage input terminal VDDIN as described in above embodiments) and after passing through the P/G meshes, is output from a system voltage output terminal (e.g., the system voltage output terminal VDDOUT as described in above embodiments). FIG. 9B illustrates transmission results that a ground voltage passes through the P/G meshes used in FIG. 9A, wherein the ground voltage is input from a ground voltage input terminal (e.g., the ground voltage input terminal VSSIN as described in above embodiments) and after passing through the P/G meshes, is output from a ground voltage output terminal (e.g., the ground voltage output terminal VSSOUT as described in above embodiments). In the present embodiment, the configuration manners of the system voltage input terminal, the system voltage output terminal, the ground voltage input terminal and the ground voltage output terminal may be deduced with reference to those illustrated in FIG. 4A through FIG. 8B, and voltage transmission paths are configured to serve as diagonal paths of the P/G meshes.

In the present embodiment, the supplied system voltage is about 1.1V±10%, and an area of each of the P/G meshes to be tested is 2000 μm*2000 μm.

In detail, curves 910 and 912 represent test results of a comparative P/G mesh in the present embodiment. A structure of the comparative P/G mesh is formed by stacking two metal wire layers on top and bottom, wherein the ground wires and the power wires are arranged in a staggered manner in each of the metal wire layers, and the metal wire layers on top and bottom are connected with each other through vias. The structure of the comparative P/G mesh is different from the P/G mesh 200, the P/G mesh 500 and the P/G mesh 700 in that each of the ground wires and each of power wires of the comparative P/G mesh are straight wires, without any 2D change. Curves 930 and 932 represent test results of the P/G mesh 200 illustrated in FIG. 4A in combination with that illustrated in FIG. 4B, curves 920 and 922 represent test results of the P/G mesh 500 illustrated in FIG. 6A in combination with that illustrated in FIG. 6B, and curves 940 and 942 represent test results of the P/G mesh 700 illustrated in FIG. 8A in combination with that illustrated in FIG. 8B. It may be known according to FIG. 9A and FIG. 9B that the P/G mesh 200, the P/G mesh 500 and the P/G mesh 700 of the invention, in comparison with the comparative P/G mesh, may achieve effectively reducing the voltage drop in transmitting either the system voltage or the ground voltage and have a preferable transmission effect.

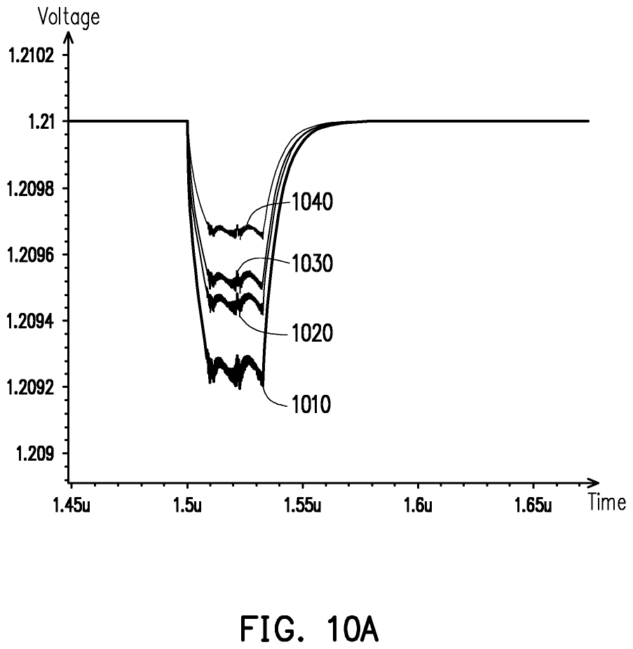

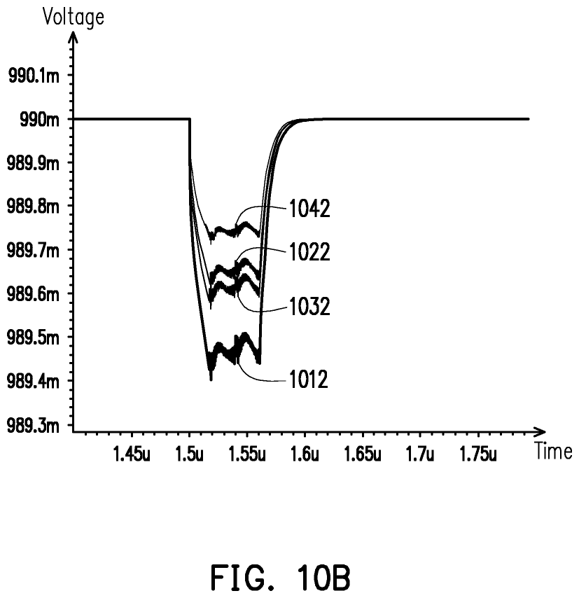

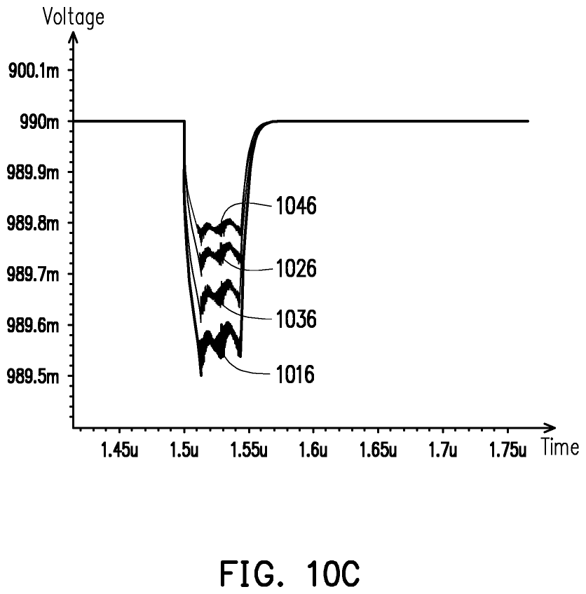

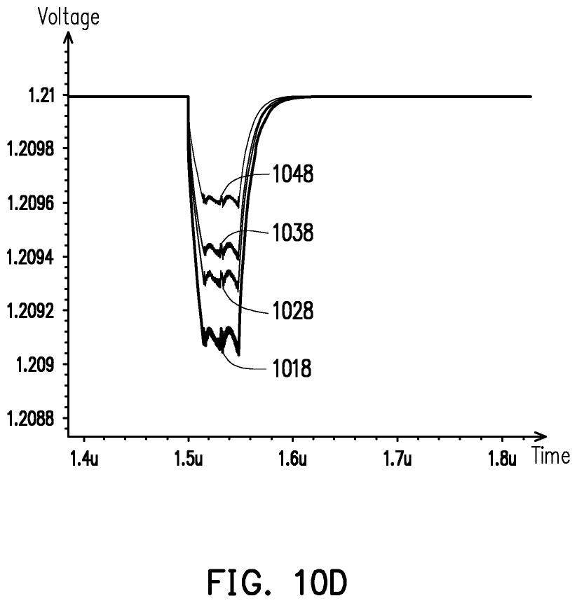

FIG. 10A through FIG. 10B are schematic diagrams respectively illustrating voltage drop tests of various P/G meshes in different process conditions according to the embodiments of the invention. In the present embodiment, it is further to prove that the P/G meshes of the invention still maintain a preferable transmission effect in different PVT (process, voltage, temperature) conditions. FIG. 10A through FIG. 10D illustrate voltage drop test results of the system voltage with respect to the comparative P/G mesh versus the P/G mesh 200, the P/G mesh 500 and the P/G mesh 700 in different process conditions. Curves 1010, 1012, 1016 and 1018 represent test results of the comparative P/G mesh, curves 1030, 1032, 1036 and 1038 represent test results of the P/G mesh 200 illustrated in FIG. 4A in combination with that illustrated in FIG. 4B, curves 1020, 1022, 1026 and 1028 represent test results of the P/G mesh 500 illustrated in FIG. 6A in combination with that illustrated in FIG. 6B, and curves 1040, 1042, 1046 and 1048 represent test results of the P/G mesh 700 illustrated in FIG. 8A in combination with that illustrated in FIG. 8B. Table 1 below numerates the process conditions of FIG. 10A through FIG. 10D.

TABLE 1

| | FIG. 10A | FIG. 10B | FIG. 10C | FIG. 10D |
|---|---|---|---|---|
| Process corner | FF | SS | SS | FF |
| Voltage (V) | 1.1 | 0.9 | 0.9 | 1.1 |
| Temperature | −40 | 125 | −40 | 125 |
| (Centigrade) | | | | |

It may be known according to FIG. 10A and FIG. 10D that the P/G mesh 200, the P/G mesh 500 and the P/G mesh 700 of the invention, in comparison with the comparative P/G mesh, may achieve effectively reducing the voltage drop and have a preferable transmission effect. It is worthy mentioned that in a scenario that the ground voltage is transmitted, the P/G mesh 200, the P/G mesh 500 and the P/G mesh 700 of the invention still have a lower voltage in various process conditions.

Based on the above, the IC structure of the invention includes a P/G mesh for supplying a voltage to the function circuit. The structure of the P/G mesh adopts the first metal layer and the second metal layer electrically connected with each other through the vias, wherein the first metal layer and the second metal layer are respectively disposed with a plurality of ground wires and a plurality of power wires, and the ground wires and the power wires are disposed in a staggered manner. Specially, the wire impedances of the first metal layer and the second metal layer are different from each other. The wires of the P/G mesh of the invention further are placed in two-dimensional patterns, instead of the straight wires of the related art. The resistances on the signal transmission paths are averaged by rotating, shifting or flipping the 2D patterns.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An integrated circuit (IC) structure, comprising:
a function circuit; and
a power ground (P/G) mesh, electrically connected with the function circuit and comprising a first metal layer and a second metal layer, wherein the first metal layer and the second metal layer are respectively disposed with a plurality of ground wires and a plurality of power wires, the plurality of power wires of the first metal layer are electrically connected with the plurality of power wires of the second metal layer through a plurality of first vias, and the plurality of ground wires of the first metal layer are electrically connected with the plurality of ground wires of the second metal layer through a plurality of second vias, wherein a wire impedance of the first metal layer is different from a wire impedance of the second metal layer.

2. The IC structure according to claim 1, wherein the plurality of ground wires and the plurality of power wires of the first metal layer or the second metal layer constitute of two-dimensional patterns on an extension plane.

3. The IC structure according to claim 2, wherein each of the plurality of ground wires and each of the plurality of power wires of the first metal layer or the second metal layer have at least one right-angled corner.

4. The IC structure according to claim 1, wherein the plurality of ground wires and the plurality of power wires of the first metal layer are disposed in a staggered manner.

5. The IC structure according to claim 1, wherein at least a portion of wires of the plurality of ground wires and the plurality of power wires of the first metal layer form a first pattern, wherein the first pattern is a two-dimensional (2D) pattern, and a wire layout of the first metal layer is composed of the first pattern and shifting, flipping, or rotating of the first pattern.

6. The IC structure according to claim 5, wherein at least a portion of wires of the plurality of ground wires and the plurality of power wires of the second metal layer form a second pattern, wherein the second pattern is a 2D pattern, and a wire layout of the second metal layer is composed of the second pattern and shifting, flipping, or rotating of the second pattern.

7. The IC structure according to claim 6, wherein the first pattern is a stair-shaped pattern having a first direction, and the second pattern is a stair-shaped pattern having a second direction opposite to the first direction.

8. The IC structure according to claim 7, wherein between a voltage input terminal and a voltage output terminal of the P/G mesh, at least one of the plurality of ground wires and at least one of the plurality of power wires disposed correspondingly to each other comprise a stair-shaped wire having the first direction and a stair-shaped wire having the second direction.

9. The IC structure according to claim 7, wherein the wire layout of the first metal layer comprises a rectangular unit region, and the rectangular unit region comprises a first quadrant region, a second quadrant region, a third quadrant region and a fourth quadrant region, wherein in the first metal layer, the second quadrant region is formed by the first pattern, the first quadrant region and the second quadrant region are symmetrical to each other, the third quadrant region and the second quadrant region are symmetrical to each other, and the fourth quadrant region and the third quadrant region are symmetrical to each other.

10. The IC structure according to claim 9, wherein the wire layout of the second metal layer further correspondingly comprises the rectangular unit region, wherein in the second metal layer, the second quadrant region is formed by the second pattern, the first quadrant region and the second quadrant region are symmetrical to each other, the third quadrant region and the second quadrant region are symmetrical to each other, and the fourth quadrant region and the third quadrant region are symmetrical to each other.

11. The IC structure according to claim 6, wherein the first pattern comprises L-shaped patterns having an opening direction, and the second pattern comprises L-shaped patterns having an opposite opening direction to the opening direction of the first pattern.

12. The IC structure according to claim 11, wherein between a voltage input terminal and a voltage output terminal of the P/G mesh, at least one of the plurality of ground wires and at least one of the plurality of power wires disposed correspondingly to each other comprise an L-shaped wire and an L-shaped wire having the opposite opening direction.

13. The IC structure according to claim 11, wherein the wire layout of the first metal layer comprises a rectangular unit region, and the rectangular unit region comprises a first quadrant region, a second quadrant region, a third quadrant region and a fourth quadrant region, wherein in the first metal layer, the second quadrant region is formed by the first pattern, the first quadrant region and the second quadrant region are symmetrical to each other, the third quadrant region and the second quadrant region are symmetrical to each other, and the fourth quadrant region and the third quadrant region are symmetrical to each other.

14. The IC structure according to claim 13, wherein total numbers of the plurality of first vias are same as total numbers of the plurality of second vias in the first quadrant region, the second quadrant region, the third quadrant region and the fourth quadrant region.

15. The IC structure according to claim 13, wherein the wire layout of the second metal layer further correspondingly comprises the rectangular unit region, wherein in the second metal layer, the first quadrant region is formed by the second pattern, the second quadrant region and the first quadrant region are symmetrical to each other, the third quadrant region and the second quadrant region are symmetrical to each other, and the fourth quadrant region and the third quadrant region are symmetrical to each other.

16. The IC structure according to claim 6, wherein the first pattern and the second pattern have a shifting, flipping or rotating relation.

17. The IC structure according to claim 5, wherein the first pattern comprises L-shaped patterns having an opening direction, and the wire layout of the first metal layer comprises a rectangular unit region, wherein the rectangular unit region comprises a plurality of L-shaped pattern wires having different opening directions.

18. The IC structure according to claim 17, wherein a wire layout of the second metal layer further correspondingly comprises the rectangular unit region, wherein at least one of the plurality of ground wires and at least one of the plurality of power wires of the second metal layer are disposed adjacent to each other and form a spiral square shape in the rectangular unit region.

19. The IC structure according to claim 1, wherein a wire height of the first metal layer is different from a wire height of the second metal layer, or a wire width of the first metal layer is different from a wire width of the second metal layer.
